(19) United States
(12) Patent Application Publication
(10) Pub. No.: US 2014/0269538 A1
(43) Pub. Date: Sep. 18, 2014

(54) Methods And Systems For Transmitting Data Frames From a Cloud-Based System

(71) Applicant: Alcatel-Lucent Canada, Inc., Ottawa (CA)

(72) Inventors: Bao Minh Dang, Dollard-des-Ormeaux (CA); Jian G. Zhao, Kanata (CA)

(73) Assignee: Alcatel-Lucent Canada, Inc., Ottawa (CA)

(21) Appl. No.: 13/841,580

(22) Filed: Mar. 15, 2013

(51) Int. Cl. H04W 72/12; H04W 88/12

(52) U.S. Cl. CPC H04W 72/1263; H04W 88/12
USPC 370/329

(57) ABSTRACT

Audio and video data streams are transmitted from cloud-based system to one or more base transceiver stations without losing data frames by substantially ensuring that each data frame is not transmitted when it cannot be received within a reception window. Those data frames that may eligible for transmission, but are withheld from transmission, may be transmitted during a future, scheduled time interval provided the data frame can be received within a future reception window.

### BACKGROUND

In a typical wireless network a central control device referred to as a “radio network controller” (RNC) is used to transmit data frames making up a data stream to a number of distributed base transceiver stations (BTSs). In turn, each BTS transmits the data frames to a number of wireless devices/users that are within the transmission range of a given BTS.

As is well known there now exists many applications that may be used in conjunction with wireless devices. Such wireless devices include, for example, wireless telephones, smartphones and tablets. The applications may involve streams of audio and video data frames. Within a given application, specific data frames representing so-called “isochronous” events (e.g., recurring events) are typically transmitted by an RNC, and received by a BTS/wireless device, in a proper sequence and at a specific time in order for the application to function appropriately. To ensure that data frames are received in the proper sequence and at the correct time by a wireless device, an RNC typically “schedules” the transmission of each data frame associated with an isochronous event.

Recently, there is a trend towards designing “cloud-based” systems. Such a system may consist of a number of connected high-speed, high data capacity servers. Even more recently there has been discussions within the wireless communications industry to design and install cloud-based RNCs. In such a wireless network the functions of many RNCs may be centralized into a single cloud-based RNC, for example. The single cloud-based RNC may in turn comprise one or more servers, for example.

There are many challenges to be met and technical issues to be solved in order to “move” RNCs “into the cloud”. One such challenge relates to the scheduling of data frames associated with a wireless application's isochronous events. In particular, many times a wireless application involves so-called communications. In general, real-time communications require that the effects of transmission “delays” be removed or corrected before an isochronous data frame can be transmitted using traditional scheduling techniques. For example, losing portions of a received wireless video stream may cause perceived quality degradations on a tablet or smartphone. In such a circumstance the recipient of the video is acutely aware of the lost frames due to delays and the like because the video may seem distorted. Delays which cause frames to be lost or dropped may be caused by any number of physical phenomena that occur within a communications channel, and by inaccuracies/limitations introduced by the equipment which is transmitting or receiving such communications. Various techniques have been developed and implemented in traditional RNCs to offset the effects of delay in order to correctly schedule the transmission of real-time audio and video streams.

However, for various reasons these techniques cannot be applied to cloud-based RNCs. For example, cloud-based RNCs will most likely rely upon “non-real time” communications. Typically, networks designed for non-real-time communications function differently than those designed for real-time communications. Thus, many of the traditional techniques used by RNCs to remove or correct the effects of delay cannot be easily applied to cloud-based RNCs.

Accordingly, it is desirable to provide methods and related devices for scheduling the transmission of data frames from cloud-based RNCs.

### SUMMARY

Exemplary embodiments of methods and systems for transmitting data frames from within a cloud-based system are disclosed.

In one embodiment of the invention, an exemplary method for transmitting one or more data frames, that may be part of an audio or video data stream, from an RNC, or similar device, within a wireless cloud-based system to one or more BTSs may comprise: identifying an instance of time within a schedule to transmit one or more downlink data frames from the wireless cloud system; determining one or more transmission times for the one or more downlink data frames during an associated, transmission time interval; and transmitting, from the wireless cloud system, the one or more downlink data frames to a BTS during the associated transmission time interval based on a determination that one of the determined transmission times substantially ensures the one or more data frames is received within an associated, BTS reception time window. The method further comprising a determination that one of the determined transmission times substantially ensures the one or more data frames are received within an associated base transceiver station reception time window.

In a further embodiment, if it is determined (by an RNC, for example) that the one or more data frames cannot be transmitted within the associated, transmission time interval because none of the determined transmission times is estimated to substantially ensure that one or more of the data frames will be received within the associated BTS reception time window, then the one or more data frames may be transmitted to one or more BTSs during a next transmission time interval.

In a further embodiment, to substantially ensure that the one or more data frames will not be lost or dropped, before the one or more data frames are transmitted during a next transmission time interval, next transmission times may be determined at a next instance of time that the one or more data frames are scheduled for transmission. Upon determining the next transmission times the method may further determine whether one or more of the next transmission times substantially ensures that the one or more data frames will be received within a next BTS reception time window. If so, then the method continues and provides for the transmission of the one or more downlink data frames. If not, the process may be repeated until the one or more data frames can be transmitted within a next BTS reception time window.

In the embodiments set forth above and herein, a particular transmission time interval may overlap with another transmission time interval and a particular BTS reception window may overlap with another BTS reception window.

In an additional embodiment a method may include determining an amount of delay in a channel that will be used to transmit one or more data frames during an associated, transmission time interval, and determining one or more of the transmission times referenced above and herein based at least on a determined amount of delay.

In addition to novel methods, embodiments of the invention include an RNC within a cloud-based system that is operable to complete the methods set forth above. Yet further, the RNC may be within a wireless network, where the network further comprises: one or more BTSs operable to receive one or more transmitted data frames, that may be a part of an audio or video data stream, and transmit the one or more data frames to one or more mobile devices; and one or more mobile devices operable to receive the transmitted one or more data frames from the one or more BTSs.

Additional features and embodiments of the inventions will be apparent from the following detailed description and appended drawings.

### BRIEF DESCRIPTION OF THE DRAWINGS

FIG. 1 depicts an example of the transmission of data frames associated with one or more isochronous events that have been affected by delay.

FIG. 2 depicts a simplified block diagram of a network according to one embodiment of the present invention.

FIG. 3 depicts an example of the transmission, or non-transmission, of data frames associated with one or more isochronous events using components of the network in FIG. 2 in accordance with embodiments of the invention.

FIG. 4 depicts a flow diagram of an exemplary process for transmitting data frames associated with one or more isochronous events in accordance with embodiments of the invention.

### DETAILED DESCRIPTION, INCLUDING EXAMPLES

Exemplary embodiments (i.e., examples) of methods and related systems for transmitting one or more data frame from within a wireless cloud-based system are described herein in detail and shown by way of example in the drawings. Throughout the following description and drawings, like reference numbers/characters shall refer to like elements.

It should be understood that although specific structural and functional details are discussed herein for purposes of describing the exemplary embodiments, there is no intent to limit the scope of present invention to such embodiments. Practically speaking, it is next to impossible for the inventors to describe each and every variation of the inventive methods and systems. Thus, it should be understood that the exemplary embodiments discussed herein are for illustrative purposes, and that varied, modified, equivalent and alternative embodiments may be implemented without departing from the scope of the present invention.

It should be noted that some exemplary embodiments may be described as processes or methods depicted in a flow diagram. Although the flow diagram may describe the processes/methods as sequential, many of the processes/methods may be performed in parallel, concurrently or simultaneously. In addition, the order of each step within a process or method may be re-arranged. The processes/methods may be terminated when completed, may include additional steps not included in the flow diagram or may correspond to functions, procedures, subroutines, subprograms, etc., completed by a device within a wireless, cloud-based system, for example.

It should be further understood that, although the terms first, second, third, etc. may be used herein to describe various time periods, data frames, etc., the time periods, data frames, should not be limited by these terms. Such terms are used to distinguish one time frame, data frame, etc., from another. For example, a first time frame could be termed a second time frame, and, similarly, a second time frame could be termed a first time frame without departing from the scope of disclosed embodiments. As used herein, the term “or” includes any and all combinations of one or more of associated or listed items. As used herein, the singular forms “a,” “an” and “the” are not intended to include the plural form, unless the context clearly indicates otherwise.

Turning now to the figures, FIG. 1 depicts an example of the transmission of one or more downlink data frames associated with one or more scheduled isochronous events that have been affected by delay. The term “downlink” as used herein denotes a transmission from a cloud based element, such as an RNC, to a BTS, for example. The delay may be due to a number of factors, including jitter that originates in the transmission and reception equipment, or delays caused by the transmission channel used to transmit the frames. In FIG. 1, a first data frame F₁ associated with a first isochronous event is depicted as being transmitted at a time t₁ and being received at a time t₅ while a second frame F₂ associated with a second isochronous event is depicted as being transmitted at a time t₂ and being received at a time t₇. As depicted, the two frames F₁ and F₂ have been delayed. For example, instead of transmitting frame F₁ at time tₒ over channel TX₁ within a first transmission time interval TTI₁, the transmission equipment (e.g., an RNC) transmitted the frame F₁ at time t₁ amounting to a delay of d₁. Typical transmission time intervals may be 10 milliseconds (ms), 20 ms or 40 ms, for example, depending the data rate (e.g., high or low data rate). Because of the delay, the frame F₁ is not received until time t₅ which is outside the first reception window RW₁ for any data frames being transmitted during TTI₁. Typical receive windows depend on the capabilities of the BTS in use; however, one typical window is 60 ms. Regarding frame F₂, though it is transmitted at time t₂ over channel TX₂ that is within a second transmission time interval TTI₂ it is not received at reception equipment (e.g., a BTS) until time t₇ which is outside a second reception window RW₂ for any data frames being transmitted during TTI₂, resulting in a delay of d₂. In this case the delay may be caused by phenomena in the physical channel TX₂, for example, or at the reception equipment, not at the transmission equipment as was the case for the first data frame F₁.

In accordance with embodiments of the invention, FIG. 2 depicts a simplified block diagram of a non-real-time, wireless cloud-based network 1 that may be used to schedule data frames associated with isochronous events that reduces the effects of delay, such as the delays d₁ and d₂ depicted in FIG. 1.

As shown the wireless network 1 includes a cloud-based system 2 that includes a plurality of hardware servers 4ₐ through 4_{N}, where “N” is the last server within system 2. In accordance with an embodiment of the invention system 2 may comprise a cloud-based RNC 3. Though the network 1 depicted in FIG. 1 is a wireless network, it should be understood that many of the elements within network 1 may be wired or wireless. For example, the cloud-based system 2, RNC 3 and base transceiver stations, designated BTS₁, BTS₂, . . . BTS_{N}, may be wired or wirelessly connected, though the devices m₁₁, m₂₁, m_{N} are wireless devices. That is, the communications between the RNC and BTSs may be via wired pathways and connections while the communications between a BTS and mobile device may be via wireless pathways and connections. As depicted in FIG. 2, the cloud-based RNC 3 may comprise one or more of the servers 4ₐ, 4_{b} where the servers 4ₐ, 4_{b} may be a subset of servers 4ₐ through 4_{N}. One or ore of the additional servers 4_{c} through 4_{N} may be operable to complete supporting functions related to the serves 4ₐ, 4_{b}, such as database access, data retrieval and data storage, for example. In an embodiment of the invention, the RNC 3 may be operable to transmit one or more scheduled data frames in a non-real-time basis over one or more pathways 5ₐ, 5_{b}, . . . 5_{N} to a plurality of base transceiver stations, designated BTS₁, BTS₂, . . . BTS_{N}, where “N” denotes either the last pathway or last base station, respectively. The scheduled data frames may be part of an audio or video data stream, to name just two examples. Upon receiving data frames, each of the base stations BTS₁, BTS₂, . . . BTS_{N} may be operable to transmit the data frames to one or more of a plurality of associated, mobile devices. In FIG. 2, the mobile devices associated with the first base station BTS₁ are designated m₁₁, m₂₁ m_{N} respectively, where “N” represents the last mobile device. In turn, each of the mobile devices m₁₁, m₁₂, . . . m_{N} (for example) may be operable to receive the transmitted one or more data frames from BTS₁ in order to allow a user of one or more of the mobile devices m₁₁, m₁₂, . . . m_{N} to hear or view an audio or video data stream, for example . . .

In more detail, referring to FIG. 3 there is depicted an example of the transmission, or non-transmission as the case may be, of data frames F₂₁, F₂₂, F₂₃ associated with isochronous events that may be part of an audio or video data stream using the system 2 in FIG. 2. In some embodiments of the invention the data frames F₂₁, F₂₂, F₂₃ may, or may not be, transmitted from RNC 3 to one or more of the base transceiver stations BTS₁, BTS₂, . . . BTS_{N} depending on whether or not the amount of delay associated with the scheduled transmission of a particular data frame causes the data frame to be received outside a given BTS' reception window, RW₁₁, RW₂₁, RW₃₁, respectively, and thereby lost or dropped. As illustrated in FIG. 3 the transmission time intervals TTI₁₁, TTI₂₁ and TTI₃₁ may be overlapping time intervals. Similarly, the reception windows RW₁₁, RW₂₁, RW₃₁ may be overlapping reception windows.

For example, because the scheduled transmission of data frame F₂₁ was delayed from time t₁₀ to time t₁₁ by an amount d₁₁ placing the proposed transmission of data frame F₂₁ outside of the current transmission time interval TTI₁₁ and outside the current reception window RW₁₁ (e.g., it is received at time t₁₅ instead of time t₁₄), the RNC 3 is operable to withhold the transmission of frame F₂₁ until a future, scheduled time. The dashed line labeled NTX₁ in FIG. 3 is an indication that the transmission of frame F₂₁ was not completed during the current transmission time interval. Similarly, because the reception of data frame F₂₂ was delayed from time t₁₆ to time t₁₇ by an amount d₁₂ placing the proposed reception of data frame F₂₂ outside of the current reception window RW₂₁, the RNC 3 is operable to withhold the transmission of frame F₂₂ until it a future, scheduled time. The dashed line NTX₂ in FIG. 3 is an indication that the transmission of frame F₂₂ was not completed. Because the frames were not transmitted, the frames were not lost or otherwise dropped. As a result, the data frames F21 and F22 may be transmitted at a future time.

Still referring to FIG. 3, not all of the data frames were withheld from transmission, however. For example, the solid line TX₁₃ indicates that data frame F₂₃ was transmitted at its current scheduled time t₁₃ and was received at time t₁₈ which is within current reception window RW₃₁. As illustrated in FIG. 3, in accordance with an embodiment of the invention frame F₂₃ may be transmitted by RNC 3 to one or more of the base transceiver stations BTS₁, BTS₂, . . . BTS_{N} because any current delays do not cause the scheduled transmission of data frame F₂₃ to be received outside of its associated, current reception window RW₃₁. Said another way, RNC 3 is operable to transmit frame F₂₃ to one or more base transceiver stations BTS₁, BTS₂, . . . BTS_{N} at its current scheduled time because the data frame F₂₃ will be received within its associated, current reception window RW₃₁ and not lost or dropped, for example. Upon receiving data frame F₂₃, one or more of the base transceiver stations BTS₁, BTS₂, . . . BTS_{N} may be operable to transmit the data frame F₂₃ to one or more mobile devices, such as mobile devices m₁₁, m₂₁, . . . m_{N}. Though only a single data frame F₂₃ is depicted as being transmitted it should be understood that one or more data frames may be transmitted.

In accordance with some embodiments of the invention, the RNC 3 may be operable to determine whether or not to transmit a given data frame beginning at a current scheduled time and during a current transmission time interval, or to withhold transmission of the data frame until a future scheduled time and transmission time interval. In order to do so, the RNC 3 may be operable to complete a number functions and processes. Referring to the exemplary process set forth in FIG. 4, in conjunction with the system view set forth in FIG. 2, in one embodiment of the invention the RNC 3 may be operable to identify an “instance” (e.g., a time) within a schedule to transmit one or more downlink data frames to one or more base transceiver stations BTS₁, BTS₂, . . . BTS_{N} (step 401 in FIG. 4). Upon determining an instance or time that the RNC 3 may begin to possibly transmit a downlink data frame, the RNC 3 may be further operable to determine one or more transmission times for the one or more downlink data frames during an associated, transmission time interval (step 402). Upon determining the transmission times the RNC 3 may yet be further operable to transmit the one or more downlink data frames to a base transceiver station BTS₁, BTS₂, . . . BTS_{N} during the associated transmission time interval provided the RNC 3 further determines, or has determined, that one of the determined transmission times substantially ensures (e.g., using estimates, approximations) that the one or more data frames will be received within an associated BTS reception time window (step 403), for example window RW31 in FIG. 3. By determining whether a particular data frame or frames can be transmitted during an associated, scheduled time interval the embodiments described herein ensure that fewer data frames are lost or dropped, for example. It may be said that because embodiments of the invention prevent data frames from being lost or dropped that such embodiments provide protection against problems associated with delay; protection that is typically only provided by real-time systems even though the RNC 3 is operating in a non-real-time environment.

Suppose, as illustrated in FIGS. 1 and 3, that some data frames cannot be transmitted at a given, scheduled instance of time because, for example, the RNC 3 determines that none of the determined transmission times substantially ensures that a particular data frame (or frames) will be received within an associated BTS reception time window. In one embodiment of the invention, in such a scenario the RNC 3 may be operable to transmit the particular downlink data frame or frames to one or more of the base transceiver stations BTS₁, BTS₂, . . . BTS_{N} during a future or next transmission time interval. By “next” transmission time interval means a future transmission time interval. It may, in fact, be the immediate, next interval during which the particular data frame or frames is/are scheduled to be transmitted, or it may be some future interval beyond the immediate next interval. For ease of explanation herein all future intervals, instances, transmission times, reception windows, etc., may be referred to as “next”.

In some embodiments of the invention, assuming the RNC 3 determines that a particular downlink data frame or frames were not transmitted (step 404), at a next instance of time that a particular data frame or frames may be scheduled for transmission the RNC 3 may be operable to determine next transmission times (step 405) and determine whether one of the next transmission times substantially ensures that a data frame or frames will be received within a next BTS reception time window (step 406). If so, the RNC 3 may be operable to transmit the particular downlink data frame or frames to one or more of the base transceiver stations BTS₁, BTS₂, . . . BTS_{N} (step 407). If not, the RNC 3 may repeat the above process at each next instance of time that the particular data frame or frames may be scheduled for transmission until such time as the data frame or frames can be transmitted without being lost or dropped.

In an additional embodiment of the invention, in order to determine the transmission times for one or more data frames at a particular instance of time, the RNC 3, or another device within the network 1 that is in communication with the RNC 3, may be operable to determine an amount of delay, caused by transmission equipment for example, that will be used to transmit the particular data frame or frames during an associated, transmission time interval. Upon determining the delay the RNC 3 or other device may be further operable to determine one or more of the associated transmission times based at least on a determined amount of propagation delay.

While exemplary embodiments have been shown and described herein, it should be understood that variations of the disclosed embodiments may be made without departing from the spirit and scope of the claims that follow.

We claim:

1. A method for transmitting one or more data frames from a cloud-based system comprising:
identifying an instance of time within a schedule to transmit one or more downlink data frames from a cloud-based system;
determining one or more transmission times for the one or more data frames during an associated, transmission time interval; and
transmitting, from the cloud-based system, the one or more downlink data frames to a base transceiver station during the associated transmission time interval based on a determination that one of the determined transmission times substantially ensures the one or more data frames are received within an associated base transceiver station reception time window.

2. The method as in claim 1 further comprising determining that one of the determined transmission times substantially ensures the one or more data frames are received within the associated base transceiver station reception time window.

3. The method as in claim 1 further comprising transmitting the one or more downlink data frames to the base transceiver station during a next transmission time interval based on a determination that none of the determined transmission times substantially ensures that one or more of the data frames will be received within the associated base transceiver station reception time window.

4. The method as in claim 3 further comprising:
determining next transmission times, at a next instance of time that the one or more data frames are scheduled for transmission;
determining whether one of the next transmission times substantially ensures that the one or more data frames will be received within a next base transceiver station reception time window; and
transmitting the one or more downlink data frames based on a determination that one of the next determined transmission times substantially ensures that one or more of the data frames will be received within the next base transceiver station reception time window.

5. The method as in claim 1 further comprising:
determining an amount of delay in a channel that will be used to transmit the one or more data frames during the associated, transmission time interval; and
determining one or more of the transmission times based at least on a determined amount of delay.

6. The method as in claim 1 further comprising transmitting the one or more downlink data frames to the base transceiver station from a radio network controller within the wireless cloud system.

7. The method as in claim 1 wherein the transmission time interval overlaps with another transmission time interval and the base transceiver station reception window overlaps with another reception window.

8. The method as in claim 1 wherein the one or more data frames are part of an audio data stream.

9. The method as in claim 1 wherein the one or more data frames are part of a video data stream.

10. The method as in claim 1 wherein the cloud-based system is within a wireless network.

11. A system for transmitting a data frame from a cloud-based system comprising:
a radio network controller (RNC) operable to,
identify an instance of time within a schedule to transmit one or more downlink data frames from a cloud-based system;
determine one or more transmission times for the one or more downlink data frames during an associated, transmission time interval; and
transmit the one or more downlink data frames to a base transceiver station during the associated transmission time interval based on a determination that one of the determined transmission times substantially ensures the one or more data frames are received within an associated base transceiver station reception time window.

12. The system as in claim 11 wherein the RNC is further operable to determine that one of the determined transmission times substantially ensures the one or more data frames are received within an associated base transceiver station reception time window.

13. The system as in claim 11 wherein the RNC is further operable to transmit the one or more downlink data frames to the base station during a next transmission time interval when none of the one or more determined transmission times insures the one or more data frames will be received within the associated base station reception time window.

14. The system as in claim 13 wherein the RNC is further operable to:
determine next transmission times, at a next instance of time that the one or more data frames ares scheduled for transmission;
determine whether one or more of the next transmission times insures that the one or more data frames will be received within a next base transceiver station reception time window; and
transmit the one or more downlink data frames when one of the next transmission times insures that the one or more data frames will be received within the next base transceiver station reception time window.

15. The system as in claim 11 wherein the RNC is further operable to:
determine an amount of delay in a channel that will be used to transmit the one or more data frames during the associated, transmission time interval; and
determine each of the transmission times based at least on a determined amount of delay.

16. The system as in claim 11 wherein transmission time interval overlaps with another transmission time interval and the base transceiver station reception window overlaps with another reception window.

17. The system as in claim 11 wherein the RNC is within a wireless network, and the network further comprises one or more base transceiver stations operable to receive the one or more transmitted data frames and transmit the one or more data frames to one or more mobile devices.

18. The system as in claim 11 wherein the RNC is within a wireless network, and the network further comprises one or more mobile devices operable to receive the one or more transmitted data frames from one or more base transceiver stations.

19. The system as in claim 11 wherein the one or more data frames are part of an audio data stream.

20. The system as in claim 10 wherein the one or more data frames are part of a video data stream.
